(19) United States
(12) Patent Application Publication
(10) Pub. No.: US 2005/0131788 A1
(43) Pub. Date: Jun. 16, 2005

(54) Verdonik method and system for sharing ventures investments

(76) Inventor: James F. Verdonik, Raleigh, NC (US)

Correspondence Address: DANIELS DANIELS & VERDONIK, P.A., SUITE 200 GENERATION PLAZA, 1822 N.C. HIGHWAY 54 EAST, DURHAM, NC, 27713, US

(21) Appl. No.: 10/735,961

(22) Filed: Dec. 15, 2003

(51) Int. Cl. G06F 17/60

(52) U.S. Cl. 705/35

(57) ABSTRACT

A method of investing provides investment returns to investors and affiliated persons who invest in a company or affiliate thereof. All or part of the investment return is derived from the value vendors receive in transactions with the company (issuer) and its affiliates. Cash, securities or other assets are provided based on discounts from vendors, value paid to vendors and other like arrangements.

### COPYRIGHT NOTICE

This document contains material which is subject to copyright protection. The applicant has no objection to the facsimile reproduction of this patent document, as it appears in the U.S. Patent and Trademark Office (“PTO”) patent file or records or in any publication by the PTO or counterpart foreign or international instrumentalities. The applicant reserves all other rights in the copyright.

### FIELD OF THE INVENTION

The invention related to a method of structuring investments by allowing investors to capture investment returns from part of the benefits that other people and businesses gain as a result of the growth of a company.

### BACKGROUND OF THE INVENTION

In the field of investing, it is desirable to (i) increase return on investments; (ii) decrease the risk of loss; (iii) decrease the risk of dilution; and (iv) provide cash returns on investments that normally do not provide annual cash returns and are generally illiquid for many years. Methods of accomplishing the above can be used for investments in companies in a wide range of industries and at any stage of development to raise capital and by investors to achieve their investment goals. Such an approach is likely to be particularly useful in addressing many problems associated with young technology companies that rely on long-term seed capital and venture capital to fund their start-up and growth. Similarly, Vendors may wish to establish an approach to establish long-term relationships with customers and by investment bankers and other intermediaries and service providers (including lawyers and consultants) to sell securities and structure investment transactions.

To understand how such a system could be used to advantage, it is useful to understand how companies normally raise capital and the problems these capital raising practices cause or fail to address. The following example illustrates typical start-up and growth investment and capital raising practices. Not all companies go through each of these steps, but together they illustrate the basic tools utilized by growth companies and many other companies.

Step 1. Founder of company has idea and implements it.

Step 2. Founder or university or employer protects idea with patent, copyright, or trade secret protection and incurs expense.

Step 3. Company (“Issuer”) is formed. Founders invest and receive stock.

Step 4. Idea and surrounding intellectual property rights are either transferred to or licensed to the Issuer. If a university is involved, it may receive a royalty based on a percentage of sales revenue, fixed payments based on certain milestone events and/or stock.

Step 5. Issuer raises seed capital from one or more investors (“Angel Investors”) through the sale of equity and/or debt securities.

Step 6. Issuer rents space, hires professionals and consultants, hires employees and purchases equipment, goods and services from an wide range of providers (“Vendors”). Vendors sometime purchase securities of Issuers for cash or in exchange for products or services. One or more Vendors may offer Issuers discounts to attract business from the Issuers. These discounts go to reduce the operating expenses of the Issuers and are not paid to Investors. Some Vendors receive a percentage of money raised by Issuers as a result of their services. Part of these fees may consist of securities of Issuers. For example, investment bankers, broker-dealers and other finders. Investment bankers and others, however, do not share their fees with Investors. Some Vendors invest in companies to which they sell products and services and receive securities in return for either cash or products and services.

Step 7. Issuer raises more capital through the sale of additional equity and/or debt securities. These sales of securities dilute the interests of Founders and earlier Angel Investors (the “Series A Round”).

Step 8. Issuer purchases more goods and services from existing and new Vendors.

Step 9. Issuer begins selling or licensing goods, services or technology to generate revenue.

Step 10. Issuer raises more capital through sales of equity and/or debt securities (the “Series B Round”).

Step 11. Issuer obtains line of credit from bank or other lender.

Step 12. Issuer leases equipment from equipment lessor, which may be a Vendor or a financial institution. The Issuer may give the equipment lessor equity securities or a warrant in addition to lease payments.

Step 13. Issuer hires more employees and purchases more goods and services from Vendor.

Step 14. Issuer raises more capital through sales of equity and/or debt securities (the “Series C Round”).

Step 15. Issuer obtains technology through licenses from third parties (“Technology Licensors”) and agrees to pay royalties based on a percentage of sales.

Step 16. Issuer sales grow.

Step 17. More of prior steps occur.

Step 18. Issuer is either sold (“Sale) or sells its securities to the public in an initial public offering (“IPO”). Sale and IPO are hereafter referred to as (“Exit Events”).

The foregoing process are the typical steps that occurs in the founding and growth of a company.

In an ideal scenario, the Issuer meets its business plan targets on schedule, revenues grow, the Issuer becomes profitable and each time the Issuer raises money it does so at a higher valuation, with the result that the value of securities owned by Founders and Angel Investors and other earlier investors increases with each investment round as later investors pay more in each investment round. Even in the ideal situation, however, Founders, Angel Investors and other investors often receive little or no cash return on their investment until after the Exit Event occurs. All the value of their interests is illiquid.

In many cases, however, the ideal scenario does not occur. Founders are fired. Later investors purchase stock at the same or lower prices than earlier investors. Founders, Angel Investors and other earlier investors are diluted by later rounds of investments and the value of their securities decreases. This decrease may lower values substantially below the price they paid for their securities or the opportunity cost of time and effort invested by Founders. (See Investment Return Table Below)

In some cases, therefore, later round investors make money when the Exit Event occurs, but Founders, Angel Investors and other early stage investors may lose money when the Exit Event occurs.

In other cases, an Issuer may be liquidated or simply go out of business with little or no sales proceeds. In these cases, all investors may suffer losses.

A primary problem caused by the current capital raising system outlined above is that the earliest stage investors invest at a time when the risks are highest, but they often do not reap a level of reward that is commensurate with the level of risk. Later round investors, who face less risk when they invest, often obtain greater value compared to the level of risk they face.

This creates an imbalance in the availability of capital. Much more capital is available to later stage companies and insufficient amounts of capital is available to very early stage companies.

Another imbalance in the risk/reward system is that people other than investors often receive a large amount of the benefit of investments while risking little or no capital. For example, substantially all the capital invested by all investors is eventually paid to employees or vendors as companies purchase equipment, goods and services.

### SUMMARY OF THE INVENTION

One object of the invention is based on addressing the noted imbalances by transferring some of the benefits employees and vendors receive to investors, who may include persons or entities that invest cash, employees and founders who invest time and effort, universities where the Issuer's technology was developed and others.

This invention includes a method of providing and obtaining investment return, comprising: (a) an Investor making an investment in a company; (b) the investment benefiting the company by allowing it to conduct operations; and (c) the operations benefiting vendors to the company when the company purchases, leases, licenses and/or acquires products and services. The investment return from the investment is based in whole or in part on (i) the amount of products and services acquired from vendors, (ii) the amount paid for products and services acquired from vendors, (iii) the amount obligated to be paid for products and services acquired from vendors, and/or (iv) the amount of discounts and concessions agreed to by vendors. The investment return is paid by one or more of (i) the company receiving the investment, (ii) persons or entities affiliated with the company receiving the investment, (iii) vendors providing products or services, (iv) persons or entities affiliated with vendors, (v) persons or entities designated in investment documents, (vi) persons or entities designated by any person or entity described herein, (vii) other persons or entities acting on behalf of any person described herein and (viii) persons or entities acting for the benefit of any person described herein.

The invention creates a type of investment transaction, which allows investors to share in part of the economic benefits the companies (“Issuers”) in which investments are made pay or grant to service providers, vendors, employees, company insiders and others. This would be in addition to whatever return investors make on their normal debt, equity or other investments. (See Investment Return Table Below) The invention may also be used as an stand alone without any other debt, equity or other investment.

One aspect of the invention is a method of providing investment return to, or on behalf of, or for the benefit of, investors and affiliated persons and entities who invest in the same company or an affiliated company. To conduct operations the company and its affiliates need to purchase, lease license or otherwise acquire products, services and technology from a wide range of sources (“Vendors”). Under the invention, all or part of the investment return provided to, or on behalf of, or for the benefit of, investors or their affiliates is derived directly or indirectly from the value Vendors receive in their transactions with Issuers and its affiliates. This is accomplished by providing cash, securities or other tangible or intangible assets to, or on behalf of, or for the benefit of, investors and affiliates, by, or on behalf of, or for the benefit of, Vendors or their affiliates or Issuers or their affiliates. The amount of such cash, securities, or other tangible or intangible assets is calculated either (i) based on discounts or other concessions from Vendors or their affiliates, or (ii) based on the value paid or payable to Vendors and their affiliates. The invention includes specific types of agreements and documents, including those defined in the invention as Vendor Sharing Arrangements and Issuer Sharing Arrangements. The invention can also be used (i) by investors to monitor or encourage companies to limit their expenditures for products and services, (ii) by Vendors to attract new customers and increase business from existing customers and (iii) by investment bankers, brokers, dealers, attorneys, accountants and other consultants to attract business by providing services in connection with the transactions described in the invention and related transactions.

Another aspect of the invention is a process for ensuring the invention survives later investments by others in the same Issuer as more fully described in the Detailed Description of the Invention, which includes prohibitions on transfers of the benefits of the invention, penalties for attempted transfer and requirements that changes be approved by specified persons.

In another aspect, the invention involves creating investment transaction documents including provisions requiring the foregoing.

These and other more specific embodiments of the invention are discussed, hereafter, in the Detailed Description and are reflected in the claims.

The following table shows how much an early-stage investor who purchased 500,000 shares of Common Stock for $1.00 per share (constituting 25% of the Issuer's fully diluted shares) would receive on sale of the Issuer at different sale prices, if the Issuer later raises another $18,000,000 by selling Participating Preferred Stock at the prices shown in the table. Participating Preferred Stock allows each holder to receive from proceeds of sale or liquidation of the company their original investment (and sometimes more than their original investment) before the remaining sale proceeds are divided among all shareholders of the Company, including holders of Participating Preferred Stock. The table assumes no other equity shares are issued.

INVESTMENT RETURN TABLE

| | | Price | Ownership | Return to Angel Investor on Issuer Sale | | | | |
|---|---|---|---|---|---|---|---|---|
| | Aggregate | Per | % Fully | $10 | $20 | $30 | $50 | $100 |
| | Investment | Share | Diluted | million | million | million | million | million |
| Investor | $500,000 | $1.00 | 25% | | | | | |
| Common | | | | | | | | |
| Stock | | | | | | | | |
| After | $3,000,000 | $1.50 | 12.5% | | | | | |
| Series A | | | | | | | | |
| After | $5,000,000 | $1.00 | 5.5% | | | | | |
| Series B | | | | | | | | |
| After | $10,000,000 | $1.00 | 2.6% | $0 | $52,600 | $468,000 | $833,000 | $2,132,000 |
| Series C | | | | | | | | |
| INVESTMENT | $18,500,000 | | | | | | | |
| TOTAL | | | | | | | | |

| | | | | | |
|---|---|---|---|---|---|
| Sharing Payment Return* | $712,500 | $712,500 | $712,500 | $712,500 | $712,500 |
| Total Return | $712,500 | $765,100 | $1,180,500 | $1,545,500 | $2,844,500 |
| Sharing Payment as a % of Total Return | 100% | 93% | 60% | 46% | 25% |

*Calculated as described below

If (i) the Issuer also had $10 million in aggregate revenue during the period prior to the sale of the Issuer, and (ii) 25% of the Issuer's expenses were paid to Vendors covered by an Investor Sharing Arrangement and/or a Vendor Sharing Arrangement, and (iii) the agreed Sharing Payment averaged 10% of payments to covered Vendors, the Angel Investor would receive an additional $712,500 as a result of the Vendor Sharing Arrangements and/or Investor Sharing Arrangements. How this is calculated is set forth below:

CALCULATION OF ESTIMATE OF SHARING PAYMENTS

| | |
|---|---|
| $18,500,000 | Aggregate Investment |
| +10,000.000 | Revenue |
| $28,500,000 | |
| ×25% | Percentage of Vendor Payments |
| | Covered by Investor or Vendor |
| | Sharing Arrangement |
| $7,125,000 | |
| ×10% | Percentage of Vendor Payments |
| | to be Paid to Investors under |
| | Investor or Vendor Sharing |
| | Arrangement |
| $712,500 | Total Sharing Payments |

The foregoing calculation of Sharing Payment return was based on the following assumptions: (i) the Issuer had $10 million in aggregate revenue during the period prior to the sale of the Issuer, and (ii) 25% of the Issuer's expenses were paid to Vendors covered by an Investor Sharing Arrangement and/or a Vendor Sharing Arrangement, and (iii) the agreed Sharing Payment averaged 10% of payments to covered Vendors. Based on the foregoing assumptions, the Angel Investor would receive an additional $712,500 in Sharing Payments as a result of the Vendor Sharing Arrangements and/or Investor Sharing Arrangements.

The method and system of the invention can be used to (i) increase return on investments; (ii) decrease the risk of loss; (iii) decrease the risk of dilution; and (iv) provide cash returns on investments that normally do not provide annual cash returns and are generally illiquid for many years. The invention may be used with companies in a wide range of industries and at any stage of development to raise capital and by investors to achieve their investment goals. The invention, however, is likely to be particularly useful in addressing many problems associated with young technology companies that rely on long-term seed capital and venture capital to fund their start-up and growth. The invention may also be used by Vendors to establish long-term relationships with customers and by investment bankers, attorneys, accountants, consultants and other intermediaries and service providers (including lawyers and consultants) to sell securities and structure investment transactions.

To ensure the desired results are achieved it is important that Vendor Sharing Arrangements and Issuer Sharing Arrangements not be terminated or changed when new investors invest in later rounds of investment. Provisions to include in Sharing Arrangements and/or other documents to avoid termination or changes are included in the Description of Invention below.

One inherent feature of the invention that helps to insulate against early termination or changes is that the invention has been designed not to impact the way investors typically value companies. Valuation models typically focus on revenue, profit, prices paid for shares, number of fully diluted shares and other factors on which the invention has little or no impact. Issuers need not even be a party to Vendor Sharing Arrangements, although Issuers can be parties. Both Vendor Sharing Arrangements and Issuer Sharing arrangements can be designed so as not to affect the Issuer's balance sheet or operating statement.

### BRIEF DESCRIPTIONS OF THE DRAWING

FIG. 1 is a block diagram illustrating a basic Issuer Sharing Arrangement;

FIG. 2 is a block diagram illustrating a basic Vendor Sharing Arrangement;

FIG. 3 is a block diagram illustrating a basic Issuer and Vendor Sharing Arrangement;

FIG. 4 is a block diagram illustrating an Issuer and Vendor Sharing Arrangement;

FIG. 5 is a block diagram illustrating an Issuer and Vendor Sharing Arrangement where sharing payments are reinvested;

FIG. 6 is a block diagram illustrating an Issuer and Vendor Sharing Arrangement with Agent to share Payments to the investment entity;

### DETAILED DESCRIPTION OF INVENTION

Capitalized Terms used in the Description of the Invention below are defined below.

The invention includes all means by which any benefit or value (including transfers of cash, cash equivalents, Securities and/or other tangible or intangible assets of any nature) (in addition to, or in lieu of, any increase in value of an Issuer, and/or one or more Members of the Same Issuer Group, in which an Investment is made) (hereinafter referred to as a Sharing Payment), is made to, or received by, or on behalf of, or for the benefit of, any person or entity that is an Investor in an Issuer (and/or one or more Members of the Same Issuer Group) and/or any person or entity that is a Member of the Same Investor Group as such Investor, where the Sharing Payment is (i) transferred to, or on behalf of, or for the benefit of, such Investor and /or one or more Members of the Same Investor Group, by any Vendor to such Issuer and/or one or more Members of the Same Issuer Group, or any Affiliate of such a Vendor, (ii) measured by any payments or obligations to make payments, by, or on behalf, or for the benefit of an Issuer and/or one or more Members of the Same Issuer Group to any Vendor, or any Affiliate of any Vendor, or (iii) is measured by and discounts or other concessions which a Vendor or any of its Affiliates affords to the Issuer and/or any Member of the Same Issuer Group, in each case where the Investor and/or one or more Members of the Same Investor Group has made an Investment, or is considering making an Investment, in the Issuer and/or one or more Members of the Same Issuer Group, whether the transfer is made directly from Vendor or its Affiliate, or by or through the Issuer and/or one or more Members of the Same Issuer Group or any Agent or other means, In Connection with Vendor and/or any Affiliate of Vendor providing Products and/or Services to, or on behalf of, or for the benefit of, the Issuer and/or one or more Members of the Same Issuer Group.

The invention includes all uses (whether by itself, or as part of, or in conjunction with, or in connection with, any Affiliated Investment Transaction or series of Affiliated Investment Transactions, whether occurring at the same time, before and/or after, use of the invention) of (i) one or more Vendor Sharing Arrangements and/or (ii) one or more Issuer Sharing Arrangements, whether with or without an Agent, by any Investor, Member of the Same Investor Group, Issuer, Member of the Same Issuer Group, Vendor, Agent, Transaction Facilitator, Affiliate of any of the foregoing and/or any other person or entity, if use of the Vendor Sharing Arrangement and/or Issuer Sharing Arrangement has the purpose, effect or result of any one or more of the following: (i) benefiting (including transfers of cash, cash equivalents, Securities and/or other tangible or intangible assets of any nature) any Investor and/or one or more Members of the Same Investor Group (in addition to, or in lieu of, increasing the value of the Issuer, and/or one or more Members of the Same Issuer Group, in which the Investor and/or one or more Members of the Same Investor Group has Invested or is considering making an Investment), (ii) inducing any Investor, and/or one or more Members of the Same Investor Group, to enter into, close or perform any Affiliated Investment Transaction and/or make any Investment in any Issuer and/or one or more Members of the Same Issuer Group and/or (iii) inducing any Issuer and/or one or more Members of the Same Issuer Group to purchase lease, license or otherwise acquire Products and/or Services from any Vendor (and/or any Affiliate of any Vendor or the designee of any Vendor or Affiliate), which Vendor is referred to (by name or as part of a category of Vendors) in any Issuer Sharing Agreement and/or Vendor Sharing Agreement or related document or agreement, whether or not a party to such Issuer Sharing Arrangement and/or Vendor Sharing Arrangement.

Definitions:

“Affiliate” Someone is an “Affiliate” of another person or entity if they are (i) an “affiliate as defined in Rule 405 of the Securities and Exchange Commission promulgated pursuant to the Securities Act of 1933, as amended, and any successor rule or regulation, (ii) an officer, director, manager, partner, shareholder, member or other full or part record and/or beneficial owner (directly or through another person or entity) of such person or entity and/or any Affiliate of such person or entity, (iii) entirely or partially owned of record and/or beneficially owned (directly or through another person or entity) by such person or entity and/or any Affiliate of such person or entity, and/or (iv) entirely or partially owned of record and/or beneficially owned (directly or through another person or entity) by a person or entity that entirely or partially owns of record and/or beneficially owns (directly or through another person or entity) such person and/or entity and/or any Affiliate of such person or entity.

“Agent” means any person or entity to which cash, cash equivalents, Securities and/or other assets are, or are to be, paid, issued or transferred by, or on behalf of, and/or for the benefit of, (i) an Issuer and/or one or more Members of the Same Issuer Group, (ii) an Investor and/or one or more Members of the Same Investor Group, (iii) one or more Vendors and/or the Affiliates of any Vendor and/or any of their designees, and/or (iv) any other person or entity, all or part of which cash, cash equivalents, Securities and/or other tangible or intangible assets are to be forwarded by the Agent to, or on behalf of, or for the benefit of, (i) an Issuer and/or one or more Members of the Same Issuer Group, (ii) an Investor and/or one or more Members of the Same Investor Group, (iii) one or more Vendors and/or the Affiliate of any Vendor and/or any of their designees, and/or (iv) any other person or entity, pursuant to, or in connection with, any Sharing Arrangement, Affiliated Investment Transaction and/or any other oral or written agreement or other arrangement entered into in connection with, whether occurring at the same time, before or after, any Sharing Arrangement and/or Affiliated Investment Transaction or other transaction.

“Affiliated Investment Transaction” means any Investment and/or other transaction (or series of investments and/or transactions) between or among (i) an Issuer and/or one or more Members of the Same Issuer Group and (ii) an Investor and/or one or more Members of the Same Investor Group, if such Investor and/or one or more Members of the Same Investor Group and/or any of their designees receives, or is to receive or benefit from, Sharing Payments pursuant to any Sharing Arrangement involving the same Issuer and/or one or more Members of the Same Issuer Group and/or any of their designees, whether the Sharing Arrangement is entered into at the same time, before or after, the Affiliated Investment Transaction.

“Investor” in an Issuer or in a Member of the Same Issuer Group means any person or entity (and/or any Affiliate of such person or entity) that has made an Investment, is considering making an Investment, or intends to make an Investment in, or on behalf of, or for the benefit of, an Issuer and/or one or more Members of the Same Issuer Group (whether such Investment is made before, at the same time, or after, organization of, the Issuer or Member of the Same Issuer Group). Investors may, or may not, include one or more Vendors or Affiliates of Vendors.

“Investor Group” means all the following: (i) all persons and/or entities that have Invested in, or intend to Invest in, or are considering Investing in, the same Issuer and/or one or more Members of the Same Issuer Group and/or (ii) the Affiliates of the Investor and/or one or more Members of the Same Investor Group.

“Investor Group Member” or “Member of the Same Investor Group” means all persons and entities that are: (i) Investors in the same the Issuer and/or one or more Members of the Same Issuer Group, and/or (ii) any Affiliate or Agent of any Investor Group Member and/or (iii) any person or entity from which any Investor or Investor Group Member obtains capital to Invest in, or on whose behalf, of for whose benefit, any Investor Group Member Invests in, any Issuer and/or one or more Members of the Same Issuer Group and/or (iv) any person or entity that directs or otherwise causes any Investor or Investment Group Member to Invest in any Issuer and/or one or more Member of the Same Issuer Group.

“Investment” means (i) any purchase in exchange for anything of value (including, without limitation, for cash, cash equivalents, services, intellectual property and/or other tangible or intangible assets) of a Security, or option, warrant or other right to acquire any Security, (ii) any loan (whether or not constituting a Security) and/or other advance of cash, cash equivalents, Securities or other thing of value, (iii) any guaranty of any loan or other obligation, (iv) any providing security for any loan or other obligation, (v) payment of any loan or other obligation, (vi) any provision of anything of value that is in exchange for any person or entity entering into an Issuer Sharing Arrangement and/or a Vendor Sharing Arrangement or otherwise agreeing to make Sharing Payments, and/or (vii) any other transaction that would be considered an investment by persons in the financial or legal professions. “Invest in” or Investing” means the act of making an Investment, including, without limitation, signing documents and forwarding payment for any Investment.

“Investment Return” means the total amount of cash, cash equivalents, Securities, financial instruments and other tangible or intangible assets as Investor or any member of the Same Investor Group receives as a result of any Investment, including an Issuer Sharing Arrangement, a Vendor Sharing Arrangement, any other transaction covered by this invention and/or Affiliated Investment Transactions.

“Issuer” means the corporation, limited liability company, partnership, limited partnership, trust or other person, entity or organization, in which an Investment is made by, or on behalf of, or for the benefit of, an Investor and/or one or more Members of the Same Investor Group, and/or (ii) any person or entity in which, or on whose behalf, or on whose behalf an Investment is made at the direction of an Issuer or any Issuer Group Member.

“Issuer Group” means (i) an Issuer, (ii) any Affiliate of the Issuer and/or of any Issuer Group Member and (iii) any Agent of the Issuer and/or of any Issuer Group Member.

“Issuer Group Member” and/or “Member of the Same Issuer Group” means (i) the Issuer and/or (ii) any Affiliate or Agent of any the Issuer and/or of any Issuer Group Member, (iii) any person or entity in which, or on whose behalf, or for whose benefit, the Issuer and/or any Issuer Group Member makes an Investment and/or (ii) any person or entity in which, or on whose behalf, or for whose benefit, an Investment is made at the direction of an Issuer and/or one or more Members of the Same Issuer Group.

“Products and/or Services” means any products, goods, equipment, raw materials, tools, services, intellectual property, contracts, contract rights, licenses, lease interests in real property or equipment, and/or any other tangible or intangible assets of any nature whatsoever. Products and/or Services also include any investment banking, broker-dealer, legal, accounting, consulting and/or other services useful in any Investor, Issuer, Vendor or other person or entity entering into a Vendor Sharing arrangement, an Issuer Sharing Arrangement, any Affiliated Investment Transaction and/or any other transaction included in this invention.

“Security” means any stock, option warrant, other equity, debt and/or any other obligation or agreement that would constitute a “security” as defined in Section 2 of the Securities Act of 1933, as amended.

“Sharing Arrangement” means any Issuer Sharing Arrangement and/or Investor Sharing Arrangement.

“Sharing Payment” means any cash, cash equivalents, Securities, intellectual property and/or other tangible or intangible assets of any nature paid, issued and/or otherwise transferred to, or for the benefit of, or on behalf of, any Investor, one or more members of the same Investor Group and/or any or their Agents and/or any of their designees, by, or on behalf of, or for the benefit of, any Issuer, one or more Members of the Same Issuer Group, Vendor and/or Agent pursuant to any Sharing Arrangement.

“Transaction Facilitator” means any investment banker, finder, attorney, accountant, consultant and/or other person or entity, who renders any service (including, without limitation, drafting, writing, advising, counseling, interpreting, structuring, closing, introducing participants in, and/or selling) to any person or entity in connection with (i) any Sharing Arrangement and/or (ii) any Affiliated Investment Transaction. Any Affiliate and/or subcontractor to a Transaction Facilitator is a also a Transaction Facilitator.

“Vendor” means (i) any person or entity that provides, sells, leases and/or otherwise transfers Products or Services, (ii) any person or entity that provides sells, transfers and/or licenses any intellectual property and/or (iii) any Affiliate, subcontractor, assignee or designee of any Vendor. Someone is a Vendor to an Issuer and to all Members of the Same Issuer Group, if it is a Vendor to one or more Members of the Same Issuer Group.

“Vendor Sharing Arrangement” means (i) any oral or written Security, financial instrument or other agreement or obligation, (ii) that obligates one or more Vendors, Agents and/or any other persons or entities (iii) to make any Sharing Payments (with or without use of an Agent) (iv) to, on behalf of, or for the benefit of, an Investor and/or one or more Members of the Same Investor Group (v) in Connection with any Vendor (who may, or may not be named in the Vendor Sharing Arrangement) providing Products and/or Services to, or on behalf of, or for the benefit of, the Issuer and/or one or more Members the Same Issuer Group, (vi) if the Investor and/or one or more Members of the Same Investor Group (who receive the Sharing Payments, or on whose behalf, or for whose benefit, the Sharing Payments are made) has made, or is considering making, an Investment in such Issuer and/or one or more Members of the Same Issuer Group, whether such Vendor Sharing Arrangement is entered into before, at the same time or after, the Investment.

“Issuer Sharing Arrangement” means (i) any oral or written Security, financial instrument or other agreement (ii) that obligates an Issuer and/or one or more Members of the Same Issuer Group and/or any other persons or entities (iii) to make any Sharing Payments (with or without use of an Agent) (iv) to, or on behalf of, or for the benefit of, an Investor and/or one or more Members of the Same Investor Group (v) In Connection with any Vendor (who may, or may not, be named in the Issuer Sharing Arrangement) providing Products and/or Services to, on behalf of, or for the benefit of, the Issuer and/or one or more Members of the Same Issuer Group, (vi) if the Investor and/or one or more Members of the Same Investor Group (who receive the Sharing Payments, or on whose behalf, or for whose benefit, the Sharing Payments are made) has made, or is considering making, an Investment in the Issuer and/or one or more Members of the Same Issuer Group, whether such Issuer Sharing Arrangement is entered into before, at the same time or after, the Investment. Sharing Payments made to, on behalf of, or for the benefit of, any Investor and/or one or more Members of the Same Investor Group pursuant to any Issuer Sharing Arrangement and/or any Vendor Sharing Arrangement are made “In Connection” with a Vendor providing Products and/or Services, to, or on behalf of, or for the benefit of, an Issuer and/or one or more Members of the Same Issuer Group (who receive the Sharing Payments, or on whose behalf, or for whose benefit, the Sharing Payments are made), in which an Investor and/or one or more Members of the Same Investor Group has made, or is considering making, an Investment, if providing Sharing Payments to, or for the benefit of, the Investor and/or one or more Members of the Same Investor Group:
(i) becomes an obligation of the Issuer and/or one or more Members of the Same Issuer Group, Vendor, Agent and/or any other person or entity, upon, or within a designated time before or after, the provision to, or acceptance by, any person or entity (who may, or may not, be named in the Sharing Arrangement) of Products and/or Services by, on behalf of, or for the benefit of, the Issuer and/or one or more Members of the Same Issuer Group, in which the Investor and/or one or more Members of the Same Investor Group (that receives, or benefits from, the Sharing Payments), has made or is considering making, an Investment, whether the Issuer Sharing Arrangement and/or Vendor Sharing Arrangement is entered into at the same time, before, or after the Investment;
(ii) becomes an obligation of the Issuer and/or one or more Members of the Same Issuer Group, Vendor, Agent and/or any other person or entity, upon, or within a designated time before or after, any payment to, or for the benefit of, or on behalf of, any Vendor, Agent and/or any other person or entity (who may, or may not, be named in the Sharing Arrangement) who provides Products and/or Services to, or for the benefit of, or on behalf of, the Issuer and/or one or more Members of the Same Issuer Group, in which the Investor and/or one or more Members of the Same Investor Group the Issuer and/or one or more Members of the Same Issuer Group by, on behalf of, or for the benefit of, the Investor and/or one or more Members of the Same Investor Group (that receives, or benefits from, the Sharing Payments), has made or is considering making an Investment, whether the Issuer Sharing Arrangement and/or Vendor Sharing Arrangement is entered into at the same time, before, or after the Investment;
(iii) is measured by the amount of payments due or paid to, or for the benefit of, or on behalf of, any Vendor, Agent and/or other person or entity for Products and/or Services provided by Vendor, Agent and/or any other person or entity (who may, or may not, be named in the Sharing Arrangement) , to, or for the benefit of, or on behalf of, the Issuer and/or one or more Members of the Same Issuer Group, in which the Investor and/or one or more members of the same Investor Group (that receives, or benefits from, the Sharing Payments), has made or is considering making an Investment, whether the Issuer Sharing Arrangement and/or Vendor Sharing Arrangement is entered into at the same time, before, or after the Investment;
(iv) is measured by the amount of any discounts and/or other concessions agreed to by, or on behalf of, any Vendor providing Products and/or Services to, or on behalf of, or for the benefit of, the Issuer and/or any member of the same Issuer Group, in which the Investor and/or one or more Members of the Same Investor Group (that receives, or benefits from, the Sharing Payments), has made or is considering making an Investment, whether the Issuer Sharing Arrangement and/or Vendor Sharing Arrangement is entered into at the same time, before, or after the Investment; and/or
(v) would otherwise be considered by a reasonable person, knowing all the circumstances, to be connected to any Investment in, or on behalf of, or for the benefit of the Investor and/or one or more Members of the Same Investor Group (that receives, or benefits from, the Sharing Payments), whether the Sharing Arrangement is entered into at the same time, before, or after the Investment.

The foregoing definitions use terms such as “on behalf of” and “for the benefit of.” These terms mean that one person or entity is acting on behalf of another person or entity or are acting for benefit another person or entity.

Provisions of Sharing Arrangements.

The basic provisions of an Investor Sharing Arrangement and Vendor Sharing Arrangement are contained in the definitions above.

In addition to specifying the amount, conditions, timing and payees for Sharing Payments, Vendor Sharing Arrangements and/or Investor Sharing Arrangements many include any one or more of the following types of provisions or not.
References to specific Vendors covered
References to certain categories of Vendors covered
Requirements that all Vendors or specific types of Vendors or a percentage of Vendors be covered
Requirements that Investor or an Agent designate or approve the Vendors covered
Requirements that Issuers not change Vendors without approval by Investor, Agent and/or Vendors
Requirements that Issuers deal exclusively with certain Vendors for certain time periods
Requirements that Issuers order specific volumes as a condition to Vendor discounts or other concessions or Sharing Payments
Requirements that payments be made to an Agent with specifications about division of payments by the Agent.
Specification of the discount or other concessions, if any, to be afforded to Vendor to Issuer.
Provisions allowing Investor and/or an Agent to select Vendors for Issuer and/or negotiate arrangements with Vendors.

The specific structure for making Sharing Payments may vary according to the desired tax and accounting treatment and concerns about bankruptcy or other considerations. The mechanism for Investors or their designees receiving Sharing Payments may include any one or more of the following, which may be included in the Issuer Sharing Arrangement, Vendor Sharing Arrangement and/or in another Security, agreement, or other document.
Repurchase of all or some of the Investor's Securities of Issuer tied to the amount and timing of payment obligations in the Vendor Sharing Arrangement or Issuer Sharing Arrangements.
A secured or unsecured recourse or non-recourse promissory note with the amount and timing of repayments tied to the amount and timing of payment obligations in the Vendor Sharing Arrangement or Issuer Sharing Arrangement.
Dividends tied to the amount and timing of payments in the Vendor Sharing Arrangement or Issuer Sharing Arrangements.
Contractual obligations by the Vendors to pay Investors, Agent and/or their designees.
Contractual obligations of Issuers to pay Investors, Agent and/or their designees.
Other mechanisms which may have a better tax, accounting or bankruptcy result.

Vendor Sharing Arrangements and/or Issuer Sharing Arrangements may include requirements that part or all of (i) the investment by Investors in Issuers; and/or (ii) payments from Issuers to or on behalf of Investors and/or Vendors and/or (iii) payments by Vendor to or on behalf of Investors and/or Issuers, be made to one or more third party collection Agents. Agents may have the duty and/or right to (i) verify compliance with Sharing Agreements; (ii) collect and/or make payments as required by Sharing Arrangements, (iii) protect cash from creditors of Issuers; and/or (iv) collect license fees for the owner of the invention. These Agents could also solicit and/or certify Vendors who desire to participate in Vendor Sharing Arrangements, maintain databases of Investors who like to invest in transactions that utilize Issuer Sharing Arrangements and/or Vendor Sharing Arrangements and introduce Investors, Issuers and Vendors to one another. These Agents might be owned by Investors, Vendors, Issuer or the owner or licensee of this invention, or be licensed by the owner of this invention, franchised by the owner of this invention or operate under another type of contract with an Investor, Vendor, Issuer or the owner or licensee of this invention. One or more trademarks may also be licensed. These Agents may be organized with regional territories, by industry or by other means.

In transactions between Issuers and Vendors either:
(i) Issuer makes purchases from Vendors without discounts or other concessions from Vendors; or
(ii) Vendor agrees to afford Issuer discounts and/or other concessions, all or part of which are shared with Investors.

The invention can be utilized (i) by itself as an independent investment, or (ii) in combination with any other type of equity and/or debt Security, promissory note, financial instrument, contract and/or other investment or other transaction.

The invention can be utilized by using computers (with or without a printer) or without using a computer.

Termination or Change of Sharing Arrangements.

Convincing later round investors not to require termination of Sharing Arrangements or changing Vendors as a condition to future investments may be very important to the return on investment Investors realize from Sharing Arrangements. If these terminations or changes occur, the amount recovered by Investors from Sharing arrangements may be limited to a percentage of the amount the Investor invests, which may constitute only a small portion of funds Issuers use to make purchases from Vendors.

Provisions to Protect Against Early Termination and Changes.

One inherent feature of the invention that helps to insulate against early termination or changes is that the invention has been designed not to impact the way investors typically value companies. Valuation models typically focus on revenue, profit, prices paid for shares, number of fully diluted shares, and other factors on which the invention has little or no impact. Issuers need not even be a party to Vendor Sharing Arrangements, although Issuers can be parties. Both Vendor Sharing Arrangements and Issuer Sharing arrangements can be designed so as not to affect the Issuer's balance sheet or operating statement.

Nevertheless, it may be useful to include in the invention specific provisions that insulate against early termination or changes, or the Issuer changing to Vendors who are not covered by Sharing Agreements.

The invention may include a provision that makes termination of the Issuer Sharing Arrangement and/or Vendor Sharing Arrangement subject to approval by Investor, Vendor, Agent and/or a third party who is not the Issuer, Investor, Agent or Vendor. Such third party might become a party to the Issuer Sharing Arrangement and/or the Vendor Sharing Arrangement or might be a third party beneficiary who receives some benefit from the Issuer Sharing Arrangement and/or Vendor Sharing Arrangement. This benefit could include a percentage of the amounts payable pursuant to such arrangements. This third party would have a vested interest in not terminating the arrangement and would therefore make it more difficult to terminate the arrangement. Since later investors may require Investors to either agree to waive their right to receive payments or to assign their right to receive payments, an alternative method would be to include provisions that rights to receive Sharing Payments cannot be assigned without the consent of the third party and/or that the right to receive Sharing Payments would automatically be transferred to the third party upon any attempt to waive or attempt to assign or transfer or any attempt by the Issuer to change Vendors. This person may become a part, to the investment agreements, or a third party beneficiary by reason of their having an economic interest in continuation of the obligation to make Sharing Payments. Alternatively, there could be a provision that requires the Issuer or other designated person or entity to pay a termination fee to Investor, Agent or other person or entity, if the Issuer Sharing Arrangement or Vendor Sharing Arrangement is terminated or amended or if the Issuer changes to Vendors who are not covered by Issuer Sharing Arrangements or Vendor Sharing Arrangements. The termination fee may discourage terminations or changes.

The invention may include agreements by current or later-stage investors not to require Sharing Arrangements to be terminated or changed as a condition to their later stage investments and/or not to require a change in Vendors, which would reduce or terminate payments under Sharing Agreements as a condition to later stage investments.

One or more of the following types of provisions could be included in an Issuer Sharing Arrangement and/or a Vendor Sharing Arrangement to encourage later investors not to require termination of Issuer Sharing Arrangements and/or Vendor Sharing Arrangements:
Dollar limit on Sharing Payments
Time limit on Sharing Payments
Provisions requiring specific Vendors to be used
Provisions requiring specific classes of Vendors to be used
Provisions terminating or suspending Sharing Payment obligations upon the occurrence of specific events
Provisions allowing Investor, an Agent or their designees to select all or certain categories of Vendors for Issuer and/or negotiate arrangements with Vendor.

Illustration of Certain Provisions.

Issuer Sharing Arrangements may be in stand alone agreements or other documents, or be incorporated into other agreements or documents, including, without limitation, promissory notes (whether or not convertible or secured or unsecured, recourse or non-recourse), debentures, warrants, options, certificates or articles of incorporation, stock redemption agreements and/or other financial or investment agreements or instruments. A sample Issuer Sharing Arrangement in stand alone form is set forth below. Provisions from one agreement to the next may vary depending on the circumstances and goals of the parties and this sample is provided only as an example of one preferred embodiment of the invention. [Brackets] indicate an example of alternate alternative language that might be added in addition to, or in lieu of, the language not in [brackets].

[image]

[image]

[image]

[image]

[image]

[image]

[image]

[image]

[image]

[image]

Sample Language to Include in other Documents

Provisions that make different types of agreements, instruments and documents into Sharing Arrangements may be incorporated into many types agreements or documents, including, without limitation, promissory notes (whether or not convertible or secured or unsecured, recourse or non-recourse), debentures, warrants, options, certificates or articles of incorporation, stock redemption agreement and/or other financial or investment agreements or instruments. Sample provisions for making these other documents into Sharing Arrangements is set forth below. Provisions from one agreement, instrument or other document to the next may vary depending on the circumstances and goals of the parties and these samples are provided only as examples of one of many embodiments of the invention. [Brackets] indicate examples of language that may be added in addition to, or in lieu of, language that is not in [brackets].

Promissory Notes

Addition of the following language to a standard promissory note would make the promissory note part of an Issuer Sharing Arrangement:

Issuer shall make payments (“Sharing Payments”) to Note holder as and when Issuer and/or one or more of its Affiliates purchase Products and/or Services from the persons or entities listed on Schedule 1 hereto (“Vendors”) and/or from one or more Affiliates of any Vendor. The amount of each Sharing Payment shall be the Percentage listed on Schedule 1 hereto of the amount paid to, on behalf of, or for the benefit of, the Vendors and/or one or more of their Affiliates. Sharing Payments shall continue to be made until an amount of Sharing Payments equal to the full principal amount of this Note, plus accrued interest, has been paid. [Except for the obligation to make Sharing Payments, Issuer shall have no obligation to make any payments pursuant to this Note.]

Warrants

Addition of the following language to a Warrant would make the Warrant part of an Issuer Sharing arrangement:

The number of shares issuable upon exercise of this Warrant shall be ______ (the Warrant Shares'), except that the number of Warrant Shares issuable upon exercise of this Warrant shall decrease at a rate of one Warrant Share for each ______ of Sharing Payments made by the Issuer to the Warrant holder. Issuer shall make payments (“Sharing Payments”) to Warrant holder as and when the Issuer and/or one or more of its Affiliates purchase Products and/or Services from the persons or entities listed on Schedule 1 hereto (“Vendors”) and/or from one or more Affiliates of any Vendor. The amount of each Sharing Payment shall be the Percentage listed on Schedule 1 hereto of the amount paid to, on behalf of, or for the benefit of, the Vendors and/or one or more of their Affiliates. Sharing Payments shall continue to be made until the number of Warrant Shares issuable upon exercise of this Warrant, together with all Warrant Shares previously issued upon exercise of this Warrant, is reduced to ______ Warrant Shares.

Certificate of Incorporation

Addition of the following language to the Certificate of Incorporation of an Issuer would make the Certificate of Incorporation part of an Issuer Sharing Arrangement:

The Issuer shall pay (“Sharing Dividend Payments”) on the ______ day of each of ______ of each ______ to holders of record of its ______ Stock, an amount equal to the Percentage listed below of the amount paid to, on behalf of, or for the benefit of, the persons and entities listed below (“Vendors”) and/or one or more of their Affiliates for the Products and/or Services listed below during the preceding calendar ______.

In addition, or in the alternative, a Certificate of Incorporation could include the following provision:

The Issuer shall redeem on the ______ day of each of ______ of each ______ from holders of record of its ______ Stock, a number of shares of ______ Stock equal to the quotient derived by dividing (i) an amount equal to the Percentage listed below of the amount paid to, on behalf of, or for the benefit of, the persons and entities listed below (“Vendors”) and/or one or more of their Affiliates for the Products and/or Services listed below during the preceding calendar ______ by (ii) $______.

Stock Purchase or Redemption Agreements

Addition of the following language to a Stock Purchase or Redemption Agreement between an Issuer and one or more Investors would make the Stock Purchase or Redemption Agreement part of an Issuer Sharing Arrangement:

The Issuer shall repurchase on the ______ day of each of ______ of each ______ from the Stockholder, a number of shares of ______ Stock equal to the quotient derived by dividing (i) an amount equal to the Percentage listed below of the amount paid to, on behalf of, or for the benefit of, the persons and entities listed below (“Vendors”) and/or one or more of their Affiliates for the Products and/or Services listed below during the preceding calendar ______ by (ii) $______.

The foregoing are only examples of the type of language used to make different types of documents part of a Sharing Arrangement. The invention covered by this Patent includes all types of provisions that cause any agreement, arrangement, instrument or other document to fall within the definition of a Sharing Arrangement.

Preferred Embodiments of Invention.

The number of steps listed in each Preferred Embodiment below do not reflect which event occurs before or after any other event.

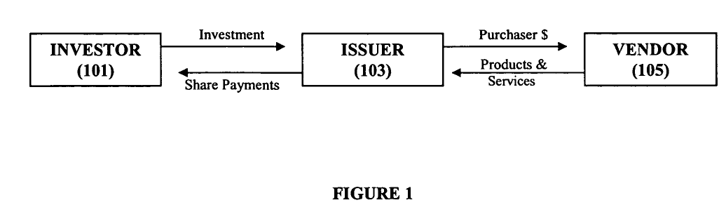

One preferred embodiment of the invention is illustrated by FIG. 1 below:

### See FIG. 1

Description of basic Issuer Sharing Arrangement as illustrated in FIG. 1:

Step 1. Investor (101) invests in Issuer (103).
Step 2. Vendor (105) sells Products and Services to Issuer (103).
Step 3. Issuer (103) pays Vendor (105) for Products and Services.
Step 4. Issuer (103) makes Sharing Payment to Investor (101) as specified in the Issuer Sharing Arrangement.

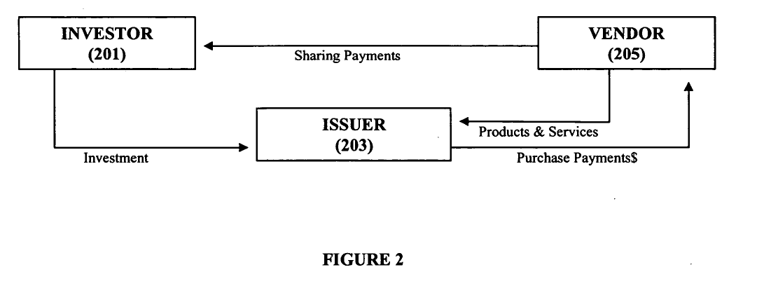

Another preferred embodiment of the invention utilizing a Vendor Sharing Arrangement is illustrated in FIG. 2 below:

### See FIG. 2

Description of basic Vendor Sharing Arrangement as illustrated in FIG. 2:

Step 1. Investor (201) invests in Issuer (203).
Step 2. Vendor (205) sells Products and Services to Issuer (203).
Step 3. Issuer (203) pays Vendor (205) for Products and Services
Step 4. Vendor (205) makes Sharing Payment to Investor (201) as specified in the Vendor Sharing Arrangement.

The Issuer may become a party to the Vendor Sharing Arrangement, or not. The same transaction could be achieved if Investor and Issuer sign an Issuer Sharing Arrangement and Vendor assumes the obligations of Issuer under the Issuer Sharing Arrangement.

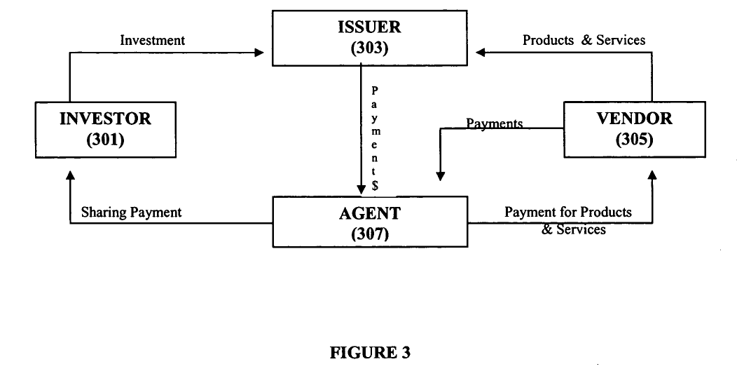

Another preferred embodiment of the invention is to utilize either an Issuer Sharing Arrangement (as illustrated in FIG. 1) or a Vendor Sharing Agreement (as illustrated in FIG. 2), and to provide in the arrangement that payments will be made by Issuer to an Agent for disbursement in accordance with the terms of the Issuer Sharing Arrangement and/or Vendor Sharing Arrangement. This transaction is illustrated in FIG. 3 below:

### See FIG. 3

Description of Issuer Sharing Arrangement and Vendor Sharing Arrangement utilizing Agent to make Sharing Payments as illustrated in FIG. 3:

Step 1. Investor (301) invests in Issuer (303)
Step 2. Issuer (303) purchases Products and Services from Vendor (305)
Step 3. Issuer (303) makes payment to Agent (307) pursuant to Issuer Sharing Arrangement
Step 4. Agent (307) makes payments to Vendor (305) for Products and/or Services
Step 5. Vendor (305) makes payment to Agent (307) pursuant to Vendor Sharing Arrangement
Step 6. Agent (307) makes Sharing Payment to Investor (301)

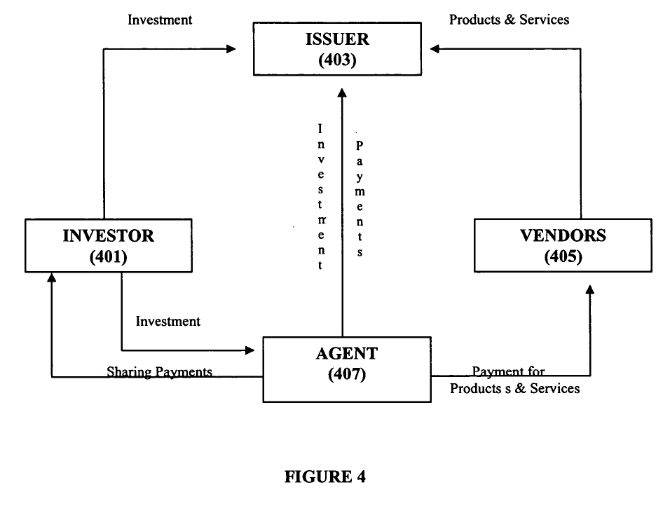

Another preferred embodiment of the invention is to utilize either an Issuer Sharing Arrangement and/or a Vendor Sharing Arrangement to provide in the arrangement that all or part of the investment will be paid by Investors to an Agent for disbursement to the Issuer, Vendors, and Investors in accordance with the terms of the Issuer Sharing Arrangement. This transaction is illustrated in FIG. 4 below.

### See FIG. 4

Description of Issuer Sharing Arrangement and Vendor Sharing Arrangement utilizing Agent to receive investments and make payments as illustrated in FIG. 4:

Step 1. Investor (401) invests in Issuer (403) by making (i) some payments to Issuer (403) and (ii) other payments to Agent (407)
Step 2. Issuer (403) purchases Products and Services from Vendor (405).
Step 3. Agent (407) pays Vendor (405) on behalf of Issuer (403) for Products and Services.
Step 4. Agent (407) makes Sharing Payments to Investors (401) on behalf of (i) Issuer (403) pursuant to Issuer Sharing Arrangement and (ii) Vendor (405) pursuant to Vendor Sharing Arrangement.
Step 5. Agent (407) pays remainder of investment to Issuer (403).

By providing all or part of the investment funds to the Agent, the Investor gains more assurance that funds will be allocated in accordance with the terms of the Issuer Sharing Arrangement or Vendor Sharing Arrangement, which may require that all or an stated portion of Issuer expenditures result in Sharing Payments.

Another preferred embodiment of the invention is for the payments pursuant to the Issuer Sharing Arrangement and/or Vendor Sharing Arrangement to be allocated for reinvestment in Issuer in a later round of investment. Payment pursuant to the Issuer Sharing Arrangement and/or Vendor Sharing Arrangement can be made either to Investor, or to an entity owned by one or more Investors, on the same terms as a prior investment, or on other terms specified in the Issuer Sharing Arrangement and/or Vendor Sharing Arrangement. An Agent could be used or not.

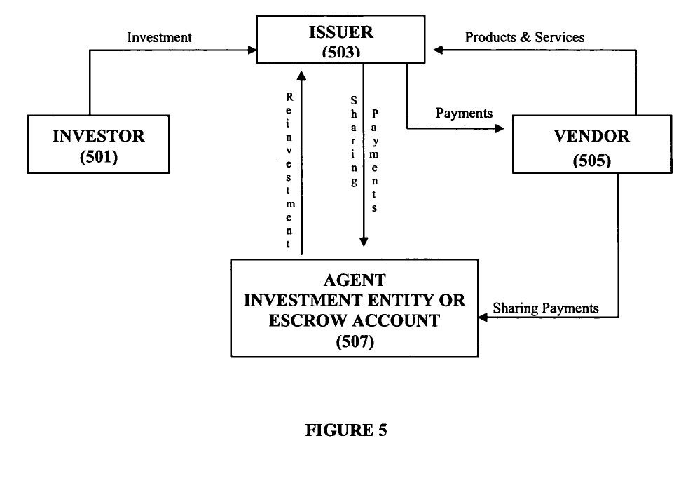

### Se FIG. 5

Description of Issuer Sharing Arrangement and Vendor Sharing Arrangement where Sharing Payments are reinvested in Issuer as illustrated in FIG. 5:
Step 1. Investor (501) invests in Issuer (503).
Step 2. Issuer (503) purchases Products and Services from Vendor (505).
Step 3. Issuer (503) pays Vendor (505) for Products and Services.
Step 4. Issuer (503) makes Sharing Payments to Agent, Investment Entity or Escrow Account (507) pursuant to Issuer Sharing Arrangement.
Step 5. Vendor (505) makes Sharing Payments to Agent, Investment Entity or Escrow Account (507) pursuant to Vendor Sharing Arrangement.
Step 6. Agent, Investment Entity or Escrow Account (507) reinvests Sharing Payments in Issuer (503) on behalf of Investor (501).

The embodiment of the invention illustrated in FIG. 5 may be used if a cash return is not important to Investor, and where the Investor's goals are (i) to have money to invest in later rounds of investment to avoid dilution, and (ii) to play a more significant role in establishing the valuation and other terms of investment in the later investment round. The embodiment of the invention illustrated in FIG. 5 is also useful where (i) the Issuer desires to have access to the additional capital from Investor and/or (ii) Investor, Vendor and/or Issuer determine later rounds of investors are more likely not to object to the Issuer Sharing Arrangement or to the Vendor Sharing Arrangement if the Sharing Payments are to be reinvested in Issuer.

Another preferred embodiment of the invention is to utilize the Sharing Payments to invest in other companies to diversify the investment portfolio of Investor. This embodiment of the investment may be utilized with either or both of the Issuer Sharing Arrangement or the Vendor Sharing Arrangement, in each case, with or without the use of an Agent.

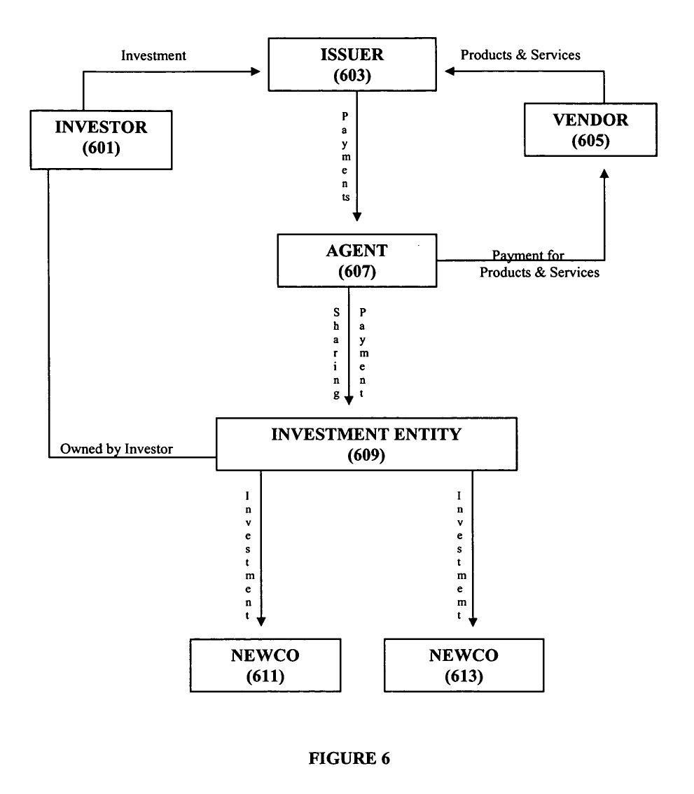

### See FIG. 6

Description of Issuer Sharing Arrangement and Vendor Sharing Arrangement with Agent to make Sharing Payments to Investment Entity to Diversify Investment as illustrated in FIG. 6:

Step 1. Investor (601) makes investment in Issuer (603).
Step 2. Issuer (603) purchases Products and Services from Vendor (605).
Step 3. Issuer (603) makes payments to Agent (607).
Step 4. Agent (607) pays Vendor (605) for Products and Services.
Step 5. Agent (607) makes Sharing Payments to Investment Entity (609) (which is owned in whole or in part by Investor (601)) pursuant to Issuer Sharing Arrangement and/or Vendor Sharing Arrangement.
Step 6. Investment Entity (609) invests in new companies—Newco (611) and Newco (613).

Having thus described the invention, the same will become better understood from the appended claims in which it is set forth in an non-limiting manner.

1. A method of providing and obtaining investment return, comprising:
(a) an Investor making an investment in a company;
(b) said investment benefiting the company by allowing it to conduct operations;
(c) said operations benefiting vendors to the company when the company at least one of purchases, leases, licenses and acquires at least one of products and services;
(d) basing the investment return from said investment in whole or in part on at least one of (i) the amount of at lest one of products and services acquired from vendors, (ii) the amount paid for the at least one of products and services acquired from vendors, (iii) the amount obligated to be paid for the at lest one of products and services acquired from vendors, and (iv) the amount of at least one of discounts and concessions agreed to by vendors; and
(e) requiring that at least part of said investment return be paid by at least one of (i) the company receiving the investment, (ii) persons or entities affiliated with the company receiving the investment, (iii) vendors providing products or services, (iv) persons or entities affiliated with said vendors, (v) persons or entities designated in investment documents, (vi) persons or entities designated by any person or entity set forth herein, (vii) other persons or entities acting on behalf of any person set forth herein and (viii) persons or entities acting for the benefit of any person set forth herein.

2. The method of claim 1, further comprising using an Agent to at least one of receive, hold and transfer at least one of payments of cash, cash equivalents, securities and tangible assets, and intangible assets.

3. The method of claim 1, further comprising requiring that at least part of the investment return be reinvested in at least one of (i) the company in which the investment was originally made (“Issuer”), (ii) persons or entities affiliated with the Issuer, (iii) persons or entities designated in investment documents, (iv) persons or entities designated by any person or entity set forth herein, (v) other persons or entities acting on behalf of any person set forth herein and (vi) persons or entities acting for the benefit of any person set forth herein.

4. The method of claim 1, further comprising requiring that at least part of the terms about investment returns not be at least one of amended and otherwise changed without the approval of a person or entity, who is not one of (i) the Issuer, (ii) persons or entities affiliated with the Issuer, (iii) the investor who originally made the investment (“Investor”), (iii) persons or entities affiliated with the Investor, (iv) persons or entities designated by any person or entity set forth herein, (v) persons or entities acting on behalf of any person set forth herein and (vi) persons or entities acting for the benefit of any person set forth herein.

5. The method of claim 4, further comprising: (a) requiring that the person or entity whose approval is required be someone who will receive a financial benefit from the continuation of the same terms about investment returns; and (b) said person being at least one of (i) a party to the transaction and (ii) a third party beneficiary of the transaction.

6. The method of claim 1, further comprising requiring that any attempt by at least one of (i) an Investor, (ii) persons or entities affiliated with the Investor, (iii) persons or entities designated by any person or entity set forth herein, (iv) persons or entities acting on behalf of any person set forth herein and (v) persons or entities acting for the benefit of any person set forth herein, to at least one of change, waive and assign the rights of at least one of an Investor and an affiliate of Investor, will cause the rights of said at least one of an Investor and an affiliate of the Investor to be transferred to at least one of (i) persons and entities designated in the investment documents, (ii) persons and entities designated by any person or entity set forth herein, (iii) persons or entities acting on behalf of any person set forth herein and (iv) persons or entities acting for the benefit of any person set forth herein.

7. The method of claim 6, further comprising requiring that the person or entity to which the rights of the at least one of an Investor and an affiliate of Investor are transferred be a person or entity who will receive a financial benefit from the continuation of the same terms about investment returns, said person being at least one of (i) a party to the transaction and (ii) a third party beneficiary of the transaction.

8. The method of claim 1, further comprising requiring that at least one of (i) the Issuer, (ii) affiliates of the Issuer, (iii) persons or entities designated by any person or entity set forth herein, (iv) persons or entities acting on behalf of any person set forth herein and (v) persons or entities acting for the benefit of any person set forth herein, at least one of purchase, lease, license and acquire at least one of products and services from at least one of (i) specified vendors, (ii) persons or entities affiliated with specified vendors, (iii) persons or entities approved by Investor, (iv) persons or entities approved by affiliates of the Investor, (v) persons or entities designated in investment documents, (vi) persons or entities designated by any person or entity set forth herein, (vii) persons or entities acting on behalf of any person set forth herein and (viii) persons or entities acting for the benefit of any person set forth herein.

9. The method of claim 1, further comprising requiring at least one of (i) vendors, (ii) persons or entities affiliated with vendors, (iii) persons or entities designated in investment documents, (iv) persons or entities designated by any person or entity set forth herein, (v) persons or entities acting on behalf of any person set forth herein and (vi) persons or entities acting for the benefit of any person set forth herein, to enter into at least one of a written agreement and an oral agreement to do at least one of (i) discount the price of at least one of products and services and (ii) make other concessions with respect to terms on which at least one of products and services are provided.

10. The method of claim 9, further comprising requiring that the economic benefits of at least one of said discounts and other concessions be transferred to at least one of (i) an Investor, (ii) persons or entities affiliated with the Investor, (iii) persons or entities approved by the Investor, (iv) persons or entities approved by affiliates of the Investor, (v) persons or entities designated in investment documents, (vi) persons or entities designated by any person or entity set forth herein, (vii) persons or entities acting on behalf of any person set forth herein and (viii) persons or entities acting for the benefit of any person set forth herein.

11. The method of claim 9, further comprising requiring that the investment return to at least one of (i) the Investor, (ii) persons or entities affiliated with the Investor, (iii) persons or entities approved by the Investor, (iv) persons or entities approved by affiliates of the Investor, (v) persons or entities designated in investment documents, (vi) persons or entities designated by any person or entity set forth herein, (vii) persons or entities acting on behalf of any person set forth herein and (viii) persons or entities acting for the benefit of any person set forth herein, be calculated based on the amount of at least one of the discount and the concessions.

12. The method of claim 1, further comprising using at least one of (i) Issuer Sharing Arrangements and (ii) Vendor Sharing Arrangements.

13. The method of claim 12, further comprising using an Agent to at least one of receive, hold and transfer at least one of payments of cash, cash equivalents, securities and tangible or intangible assets.

14. The method of claim 12, further comprising requiring that at least part of the investment return be reinvested in at least one of (i) the company in which the investment was originally made (“Issuer”), (ii) persons or entities affiliated with the Issuer, (iii) persons or entities designated in investment documents, (iv) persons or entities designated by any person or entity set forth herein, (v) persons or entities acting on behalf of any person set forth herein and (vi) persons or entities acting for the benefit of any person set forth herein.

15. The method of claim 12, further comprising requiring that at least part of the terms about investment returns not be at least one of amended and otherwise changed without the approval of a person or entity, who is not one of (i) the Issuer, (ii) persons or entities affiliated with the Issuer, (iii) the investor who originally made the investment (“Investor”), (iii) persons or entities affiliated with the Investor, (iv) persons or entities designated by any person or entity set forth herein, (v) persons or entities acting on behalf of any person set forth herein and (vi) persons or entities acting for the benefit of any person set forth herein.

16. The method of claim 15, further comprising: (a) requiring that the person or entity whose approval is required be someone who will receive a financial benefit from the continuation of the same terms about investment returns; and (b) said person being at least one of (i) a party to the transaction and (ii) a third party beneficiary of the transaction.

17. The method of claim 12, further comprising requiring that any attempt by at least one of (i) an Investor, (ii) persons or entities affiliated with the Investor, (iii) persons or entities designated by any person or entity described herein, (iv) persons or entities acting on behalf of any person described herein and (v) persons or entities acting for the benefit of any person described herein, to at least one of change, waive and assign the rights of Investor or affiliate of Investor, will cause the rights of said Investor or affiliate of the Investor to be transferred to at least one of (i) persons and entities designated in the investment documents, (ii) persons and entities designated by any person or entity set forth herein, (iii) persons or entities acting on behalf of any person set forth herein and (iv) persons or entities acting for the benefit of any person set forth herein.

18. The method of claim 17, further comprising requiring that the person or entity to which the rights of the Investor or affiliate of Investor are transferred be a person or entity who will receive a financial benefit from the continuation of the same terms about investment returns, said person being at least one of (i) a party to the transaction and (ii) a third party beneficiary of the transaction.

19. The method of claim 12, further comprising requiring that at least one of (i) the Issuer, (ii) persons or entities affiliated with the Issuer, (iii) persons or entities designated by any person or entity described herein, (iv) persons or entities acting on behalf of any person set forth herein and (v) persons or entities acting for the benefit of any person set forth herein, at least one of purchase, lease, license and acquire at least one of products and services from at least one of (i) specified vendors, (ii) persons or entities affiliated with specified vendors, (iii) persons or entities approved by Investor, (iv) persons or entities approved by affiliates of the Investor, (v) persons or entities designated in investment documents, (vi) persons or entities designated by any person or entity set forth herein, (vii) persons or entities acting on behalf of any person set forth herein and (viii) persons or entities acting for the benefit of any person set forth herein.

20. The method of claim 12, further comprising requiring at least one of (i) vendors, (ii) persons or entities affiliated with vendors, (iii) persons or entities designated in investment documents, (iv) persons or entities designated by any person or entity set forth herein, (v) persons or entities acting on behalf of any person set forth herein and (vi) persons or entities acting for the benefit of any person set forth herein, to enter into at least one of a written agreement and an oral agreement to do at least one of (i) discount the price of at least one of products and services and (ii) make other concessions with respect to terms on which at least one of products and services are provided.

21. The method of claim 20, further comprising requiring that the economic benefits of said at least one of said discounts and other concessions be transferred to at least one of (i) an Investor, (ii) persons or entities affiliated with the Investor, (iii) persons or entities approved by the Investor, (iv) persons or entities approved by affiliates of the Investor, (v) persons or entities designated in investment documents, (vi) persons or entities designated by any person or entity set forth herein, (vii) persons or entities acting on behalf of any person set forth herein and (viii) persons or entities acting for the benefit of any person set forth herein.

22. The method of claim 20, further comprising requiring that the investment return to at least one of (i) the Investor, (ii) persons or entities affiliated with the Investor, (iii) persons or entities approved by the Investor, (iv) persons or entities approved by affiliates of the Investor, (v) persons or entities designated in investment documents, (vi) persons or entities designated by any person or entity set forth herein, (vii) persons or entities acting on behalf of any person set forth herein and (viii) persons or entities acting for the benefit of any person set forth herein, be calculated based on the amount of at least one of the discount and concessions.

23. A method of at least one of selling, leasing, licensing and otherwise providing at least one of products and services to at least one of (i) an Issuer (ii) persons or entities affiliated with the Issuer, (iii) vendors providing products or services, (iv) persons or entities affiliated with said vendors, (v) persons or entities designated in investment documents, (vi) persons or entities designated by any person or entity set forth herein, (vii) other persons or entities acting on behalf of any person set forth herein and (viii) persons or entities acting for the benefit of any person set forth herein, which assists at least one of (i) an Issuer (ii) persons or entities affiliated with the Issuer, (iii) vendors providing at least one of products and services, (iv) persons or entities affiliated with said vendors, (v) persons or entities designated in investment documents, (vi) persons or entities designated by any person or entity set forth herein, (vii) other persons or entities acting on behalf of any person set forth herein and (viii) persons or entities acting for the benefit of any person set forth herein, to provide an investment return utilizing the method providing and obtaining an investment return in accordance with the method of claim 1.

24. The method of claim 23, further comprising requiring that at least one of (i) the Issuer, (ii) persons or entities affiliated with the Issuer, (iii) persons or entities designated by any person or entity described herein, (iv) persons or entities acting on behalf of any person described herein, and (v) persons or entities acting for the benefit of any person described herein, at least one of purchase, lease, license and acquire at least one of products and services from at least one of (i) specified vendors, (ii) persons or entities affiliated with specified vendors, (iii) persons or entities approved by Investor, (iv) persons or entities approved by affiliates of the Investor, (v) persons or entities designated in investment documents, (vi) persons or entities designated by any person or entity set forth herein, (vii) persons or entities acting on behalf of any person set forth herein and (viii) persons or entities acting for the benefit of any person set forth herein.

25. The method of claim 23, further comprising requiring at least one of (i) vendors, (ii) affiliates of vendors, (iii) persons or entities designated in investment documents, (iv) persons or entities designated by any person or entity set forth herein, (v) persons or entities acting on behalf of any person set forth herein and (vi) persons or entities acting for the benefit of any person set forth herein, to enter into at least one of a written agreement and an oral agreement to do at least one of (i) discount the price of at least one of products and services and (ii) make other concessions with respect to terms on which at least one of products and services are provided.

26. The method of claim 25, further comprising requiring that the economic benefits of at least one of said discounts and other concessions be transferred to at least one of (i) an Investor, (ii) persons or entities affiliated with the Investor, (iii) persons or entities approved by the Investor, (iv) persons or entities approved by affiliates of the Investor, (v) persons or entities designated in investment documents, (vi) persons or entities designated by any person or entity set forth herein, (vii) persons or entities acting on behalf of any person set forth herein and (viii) persons or entities acting for the benefit of any person set forth herein.

27. The method of claim 25, further comprising requiring that the investment return to at least one of (i) the Investor, (ii) persons or entities affiliated with the Investor, (iii) persons or entities approved by the Investor, (iv) persons or entities approved by affiliates of the Investor, (v) persons or entities designated in investment documents, (vi) persons or entities designated by any person or entity set forth herein, (vii) persons or entities acting on behalf of any person set forth herein and (viii) persons or entities acting for the benefit of any person set forth herein, be calculated based on the amount of at least one of the discount and concessions.

28. A method of at least one of selling, leasing, licensing and otherwise providing at least one of products and services to at least one of (i) an Issuer (ii) persons or entities affiliated with the Issuer, (iii) vendors providing at least one of products and services, (iv) persons or entities affiliated with said vendors, (v) persons or entities designated in investment documents, (vi) persons or entities designated by any person or entity set forth herein, (vii) other persons or entities acting on behalf of any person set forth herein and (viii) persons or entities acting for the benefit of any person set forth herein, which assists at least one of (i) an Issuer (ii) persons or entities affiliated with the Issuer, (iii) vendors providing at least one of products and services, (iv) persons or entities affiliated with said vendors, (v) persons or entities designated in investment documents, (vi) persons or entities designated by any person or entity set forth herein, (vii) other persons or entities acting on behalf of any person set forth herein and (viii) persons or entities acting for the benefit of any person set forth herein, to provide investment return utilizing the method providing and obtaining an investment return in accordance with the method of claim 12.

29. The method of claim 28, further comprising requiring that at least one of (i) the Issuer, (ii) persons or entities affiliated with the Issuer, (iii) persons or entities designated by any person or entity set forth herein, (iv) persons or entities acting on behalf of any person set forth herein and (v) persons or entities acting for the benefit of any person set forth herein, at least one of purchase, lease, license and acquire at least one of products and services from at least one of (i) specified vendors, (ii) persons or entities affiliated with specified vendors, (iii) persons or entities approved by Investor, (iv) persons or entities approved by affiliates of the Investor, (v) persons or entities designated in investment documents, (vi) persons or entities designated by any person or entity set forth herein, (vii) persons or entities acting on behalf of any person set forth herein and (viii) persons or entities acting for the benefit of any person set forth herein.

30. The method of claim 28, further comprising requiring at least one of (i) vendors, (ii) affiliates of vendors, (iii) persons or entities designated in investment documents, (iv) persons or entities designated by any person or entity set forth herein, (v) persons or entities acting on behalf of any person set forth herein and (vi) persons or entities acting for the benefit of any person set forth herein, to enter into at least one of a written agreement and an oral agreement to do at least one of (i) discount the price of at least one of products and services, and (ii) make other concessions with respect to terms on which at least one of products and services are provided.

31. The method of claim 30, further comprising requiring that the economic benefits of said at least one of said discounts and other concessions be transferred to at least one of (i) an Investor, (ii) persons or entities affiliated with the Investor, (iii) persons or entities approved by the Investor, (iv) persons or entities approved by affiliates of the Investor, (v) persons or entities designated in investment documents, (vi) persons or entities designated by any person or entity set forth herein, (vii) persons or entities acting on behalf of any person set forth herein and (viii) persons or entities acting for the benefit of any person set forth herein.

32. The method of claim 30, further comprising requiring that the investment return to at least one of (i) the Investor, (ii) persons or entities affiliated with the Investor, (iii) persons or entities approved by the Investor, (iv) persons or entities approved by affiliates of the Investor, (v) persons or entities designated in investment documents, (vi) persons or entities designated by any person or entity set forth herein, (vii) persons or entities acting on behalf of any person set forth herein and (viii) persons or entities acting for the benefit of any person set forth herein, be calculated based on the amount of at least one of the discount and concessions.

33. A method of at least one of providing and selling at least one of investment banking, broker-dealer, legal, consulting and other types of services (“Adviser Services”) to at least one of (i) Issuers (ii) persons or entities affiliated with Issuers, (iii) Investors, (iv) persons or entities affiliated with Investors, (v) vendors providing at least one of products and services to a person or entity set forth herein, (vi) persons or entities affiliated with said vendors, (vii) persons or entities designated in investment documents related to said investment, (viii) persons or entities designated by any person or entity set forth herein, (ix) other persons or entities acting on behalf of any person set forth herein and (x) persons or entities acting for the benefit of any person or entity set forth herein (“Client(s)”), comprising as part of Adviser Services, assisting at least one Client to enter into at least one part of a transaction utilizing the method of providing and obtaining an investment return in accordance with the method of claim 1.

34. A method of at least one of providing and selling at least one of investment banking, broker-dealer, legal, consulting and other types of services (“Adviser Services”) to at least one of (i) Issuers (ii) persons or entities affiliated with Issuers, (iii) Investors, (iv) persons or entities affiliated with Investors, (v) vendors providing at least one of products and services to a person or entity set forth herein, (vi) persons or entities affiliated with said vendors, (vii) persons or entities designated in investment documents related to said investment, (viii) persons or entities designated by any person or entity set forth herein, (ix) other persons or entities acting on behalf of any person set forth herein and (x) persons or entities acting for the benefit of any person or entity set forth herein (“Client(s)”), comprising as part of Adviser Services, assisting at least one Client to enter into at least one part of a transaction utilizing the method of providing and obtaining an investment return in accordance with the method of claim 4.

35. A method of at least one of providing and selling at least one of investment banking, broker-dealer, legal, consulting and other types of services (“Adviser Services”) to at least one of (i) Issuers (ii) persons or entities affiliated with Issuers, (iii) Investors, (iv) persons or entities affiliated with Investors, (v) vendors providing at least one of products and services to a person or entity set forth herein, (vi) persons or entities affiliated with said vendors, (vii) persons or entities designated in investment documents related to said investment, (viii) persons or entities designated by any person or entity set forth herein, (ix) other persons or entities acting on behalf of any person set forth herein and (x) persons or entities acting for the benefit of any person or entity set forth herein (“Client(s)”), comprising as part of Adviser Services, assisting at least one Client to enter into at least one part of a transaction utilizing the method of providing and obtaining an investment return in accordance with the method of claim 5.

36. A method of at least one of providing and selling at least one of investment banking, broker-dealer, legal, consulting and other types of services (“Adviser Services”) to at least one of (i) Issuers (ii) persons or entities affiliated with Issuers, (iii) Investors, (iv) persons or entities affiliated with Investors, (v) vendors providing at least one of products and services to a person or entity set forth herein, (vi) persons or entities affiliated with said vendors, (vii) persons or entities designated in investment documents related to said investment, (viii) persons or entities designated by any person or entity set forth herein, (ix) other persons or entities acting on behalf of any person set forth herein and (x) persons or entities acting for the benefit of any person or entity set forth herein (“Client(s)”), comprising as part of Adviser Services, assisting at least one Client to enter into at least one part of a transaction utilizing the method of providing and obtaining an investment return in accordance with the method of claim 6.

37. A method of at least one of providing and selling at least one of investment banking, broker-dealer, legal, consulting and other types of services (“Adviser Services”) to at least one of (i) Issuers (ii) persons or entities affiliated with Issuers, (iii) Investors, (iv) persons or entities affiliated with Investors, (v) vendors providing at least one of products and services to a person or entity described herein, (vi) persons or entities affiliated with said vendors, (vii) persons or entities designated in investment documents related to said investment, (viii) persons or entities designated by any person or entity set forth herein, (ix) other persons or entities acting on behalf of any person set forth herein and (x) persons or entities acting for the benefit of any person or entity set forth herein (“Client(s)”), comprising as part of Adviser Services, assisting at least one Client to enter into at least one part of a transaction utilizing the method of providing and obtaining an investment return in accordance with the method of claim 6.

38. A method of at least one of providing and selling at least one of investment banking, broker-dealer, legal, consulting and other types of services (“Adviser Services”) to at least one of (i) Issuers (ii) persons or entities affiliated with Issuers, (iii) Investors, (iv) persons or entities affiliated with Investors, (v) vendors providing at least one of products and services to a person or entity set forth herein, (vi) persons or entities affiliated with said vendors, (vii) persons or entities designated in investment documents related to said investment, (viii) persons or entities designated by any person or entity set forth herein, (ix) other persons or entities acting on behalf of any person set forth herein and (x) persons or entities acting for the benefit of any person or entity set forth herein (“Client(s)”), comprising as part of Adviser Services, assisting at least one Client to enter into at least one part of a transaction utilizing the method of providing and obtaining an investment return in accordance with the method of claim 7.

39. A method of at least one of providing and selling at least one of investment banking, broker-dealer, legal, consulting and other types of services (“Adviser Services”) to at least one of (i) Issuers (ii) persons or entities affiliated with Issuers, (iii) Investors, (iv) persons or entities affiliated with Investors, (v) vendors providing at least one of products and services to a person or entity set forth herein, (vi) persons or entities affiliated with said vendors, (vii) persons or entities designated in investment documents related to said investment, (viii) persons or entities designated by any person or entity set forth herein, (ix) other persons or entities acting on behalf of any person set forth herein and (x) persons or entities acting for the benefit of any person or entity set forth herein (“Client(s)”), comprising as part of Adviser Services, assisting at least one Client to enter into at least one part of a transaction utilizing the method of providing and obtaining an investment return in accordance with the method of claim 12.

40. A method of at least one of providing and selling at least one of investment banking, broker-dealer, legal, consulting and other types of services (“Adviser Services”) to at least one of (i) Issuers (ii) persons or entities affiliated with Issuers, (iii) Investors, (iv) persons or entities affiliated with Investors, (v) vendors providing at least one of products and services to a person or entity set forth herein, (vi) persons or entities affiliated with said vendors, (vii) persons or entities designated in investment documents related to said investment, (viii) persons or entities designated by any person or entity set forth herein, (ix) other persons or entities acting on behalf of any person set forth herein and (x) persons or entities acting for the benefit of any person or entity set forth herein (“Client(s)”), comprising as part of Adviser Services, assisting at least one Client to enter into at least one part of a transaction utilizing the method of providing and obtaining an investment return in accordance with the method of claim 15.

41. A method of at least one of providing and selling at least one of investment banking, broker-dealer, legal, consulting and other types of services (“Adviser Services”) to at least one of (i) Issuers (ii) persons or entities affiliated with Issuers, (iii) Investors, (iv) persons or entities affiliated with Investors, (v) vendors providing at least one of products and services to a person or entity set forth herein, (vi) persons or entities affiliated with said vendors, (vii) persons or entities designated in investment documents related to said investment, (viii) persons or entities designated by any person or entity set forth herein, (ix) other persons or entities acting on behalf of any person set forth herein and (x) persons or entities acting for the benefit of any person or entity set forth herein (“Client(s)”), comprising as part of Adviser Services, assisting at least one Client to enter into at least one part of a transaction utilizing the method of providing and obtaining an investment return in accordance with the method of claim 16.

42. A method of at least one of providing and selling at least one of investment banking, broker-dealer, legal, consulting and other types of services (“Adviser Services”) to at least one of (i) Issuers (ii) persons or entities affiliated with Issuers, (iii) Investors, (iv) persons or entities affiliated with Investors, (v) vendors providing at least one of products and services to a person or entity set forth herein, (vi) persons or entities affiliated with said vendors, (vii) persons or entities designated in investment documents related to said investment, (viii) persons or entities designated by any person or entity set forth herein, (ix) other persons or entities acting on behalf of any person set forth herein and (x) persons or entities acting for the benefit of any person or entity set forth herein (“Client(s)”), comprising as part of Adviser Services, assisting at least one Client to enter into at least one part of a transaction utilizing the method of providing and obtaining an investment return in accordance with the method of claim 17.

43. A method of at least one of providing and selling at least one of investment banking, broker-dealer, legal, consulting and other types of services (“Adviser Services”) to at least one of (i) Issuers (ii) persons or entities affiliated with Issuers, (iii) Investors, (iv) persons or entities affiliated with Investors, (v) vendors providing at least one of products and services to a person or entity set forth herein, (vi) persons or entities affiliated with said vendors, (vii) persons or entities designated in investment documents related to said investment, (viii) persons or entities designated by any person or entity set forth herein, (ix) other persons or entities acting on behalf of any person set forth herein and (x) persons or entities acting for the benefit of any person or entity set forth herein (“Client(s)”), comprising as part of Adviser Services, assisting at least one Client to enter into at least one part of a transaction utilizing the method of providing and obtaining an investment return in accordance with the method of claim 18.

44. A method of at least one of providing and selling at least one of investment banking, broker-dealer, legal, consulting and other types of services (“Adviser Services”) to at least one of (i) Issuers (ii) persons or entities affiliated with Issuers, (iii) Investors, (iv) persons or entities affiliated with Investors, (v) vendors providing at least one of products and services to a person or entity set forth herein, (vi) persons or entities affiliated with said vendors, (vii) persons or entities designated in investment documents related to said investment, (viii) persons or entities designated by any person or entity set forth herein, (ix) other persons or entities acting on behalf of any person set forth herein and (x) persons or entities acting for the benefit of any person or entity set forth herein (“Client(s)”), comprising as part of Adviser Services, assisting at least one Client to enter into at least one part of a transaction utilizing the method of providing and obtaining an investment return in accordance with the method of claim 23.

45. A method of at least one of providing and selling at least one of investment banking, broker-dealer, legal, consulting and other types of services (“Adviser Services”) to at least one of (i) Issuers (ii) persons or entities affiliated with Issuers, (iii) Investors, (iv) persons or entities affiliated with Investors, (v) vendors providing at least one of products and services to a person or entity set forth herein, (vi) persons or entities affiliated with said vendors, (vii) persons or entities designated in investment documents related to said investment, (viii) persons or entities designated by any person or entity set forth herein, (ix) other persons or entities acting on behalf of any person set forth herein and (x) persons or entities acting for the benefit of any person or entity set forth herein (“Client(s)”), comprising as part of Adviser Services, assisting at least one Client to enter into at least one part of a transaction utilizing the method of providing and obtaining an investment return in accordance with the method of claim 28.
